(19) United States
(12) Patent Application Publication
(10) Pub. No.: US 2017/0018924 A1
(43) Pub. Date: Jan. 19, 2017

(54) SYSTEMS AND METHODS FOR REDUCING AN ELECTRIC UTILITY RESERVE CAPACITY USING INSTRUMENTED ENERGY CONSUMING DEVICES

(71) Applicant: Power Over Time, Inc., Minneapolis, MN (US)

(72) Inventors: Nicholas Wormley, Saint Paul, MN (US); Ralph Jenson, Minneapolis, MN (US); Matthew Blackler, Minneapolis, MN (US)

(21) Appl. No.: 15/209,016

(22) Filed: Jul. 13, 2016

Related U.S. Application Data
(60) Provisional application No. 62/191,615, filed on Jul. 13, 2015.

(51) Int. Cl. H02J 3/00

(52) U.S. Cl. CPC H02J 3/00; H02J 2003/007

(57) ABSTRACT

The present disclosure relates to systems and methods for distributing power over a power distribution network. Power may be distributed across a power distribution network to power consuming devices based on power conditions and information received from control devices associated with the power consuming devices. Where power is demanded by a power consuming device, such as an electric water heater, in order to satisfy a comfort need of a consumer, the power consuming device can be prioritized and power can be allocated to that power consuming device before other consuming devices.

### CROSS-REFERENCE TO RELATED APPLICATIONS

This application claims priority to Application Ser. No. 62/191,615, entitled “Method for reducing an electric utilities reserve capacity using instrumented energy consuming devices to develop a given future energy usage over a given interval and allowing efficient energy control of said devices over a plurality of devices on a common feeder circuit” and filed on Jul. 13, 2015, and which is hereby incorporated by reference herein in its entirety.

### FIELD OF THE INVENTION

The present disclosure relates to novel and advantageous systems and methods for electric utilities to manage their reserve energy capacity.

### BACKGROUND OF THE INVENTION

Modern electric utilities provide power to residential and commercial customers for heating, cooling, lighting, and hot water. Energy usage patterns observed over a given periodic interval often show short periods of extended usage, and long periods of idle usage, where heat loss, albeit gradual, is still apparent. Further, timing of demands for energy does not always coincide with a utility's ability to generate electricity at optimal cost, resulting in lost energy and/or lost economic ability. A system that reduces a utility's reserve capacity needs would be beneficial to the utility by reducing costs during these demand periods, and ultimately using less non-profitable energy overall.

Depending on the granularity of the power measurement points over a large number of users, a number of historical measurements can be used to develop a pattern of usage for building predictive estimates of load at a given period of future time. Any estimates are imperfect, but because of the nature of the demand, there must be excess capacity, which costs utilities money. Also, energy generation costs are not always constant or optimal at a reliable periodic time interval. It is very possible that renewal energy can be variant based on environmental effects, and is unreliable for availability when demand is high.

When providing hot water for residential customers, a typical hot water service can be up to 30% of a household's total energy usage. Residential electrical water heating systems typically consist of a water heater having a large tank that holds a designed capacity of water; a water inlet, usually at the bottom of the tank; a water outlet, usually at the top of the tank; and at least two heater elements. Each heater element is typically controlled by a given thermostat associated with that heater element, where one heater element is positioned vertically higher than the other. The operation of a typical electric water heater is known. As hot water demand by the residence is realized, replacement water is allowed in through the inlet. Thermostats for each heater element detect the temperature of the water in their respective zone, and based on their settings, allow electric current to their respective heating element to heat the water. Once the temperature of the water in the thermostat's zone is reached, per the thermostat's setting, the thermostat stops electric energy to flow in its respective heating element. There are a few variable factors that differentiate one typical water heater from another, such as the wattage capacity of the heater elements; the size of the tank itself; the spacing of the heater elements vertically from each other; the size and placement of the water inlet and the outlet; thermostat settings, which are not necessarily constant even though they are commonly set at installation time and stay as such through the service lifetime of the tank; and insulation to prevent heat storage loss over time.

Energy usage of heating water for demand and economic energy creation are not necessarily aligned. Water heaters are by nature an energy storage unit. This is because actual “on demand” usage is hard to accomplish with a direct heating solution for water. The cold water drawn into the tank at the inlet at the volume needed requires a large amount of kilowatts to heat, which may be beyond the service capacity of the location. The typical water heater gradually heats the water to a service temperature over a time period. If a lot of water is used, the two heater elements try to speed the recovery time to service temperature more quickly by using both heater elements rather than just one. The time period for getting back to service temperature depends on the temperature of the inlet water, the size of the tank, the heating element capacity, and some account for heat loss. Future energy usage over a period can be relatively accurately predicted, if data is available. It may be useful for utilities to know that they will need to add more power now and how long that load will last.

Unfortunately, current or modern electric water heaters have one or more thermostats that only demand current until the water is at the predetermined temperature. It demands current by a binary act of closing or opening a contact. A plurality of electric water heaters can place demands on a given common utility feeder circuit, which may have measurement points to detect demand.

More energy efficient water heaters may have timers to heat water in off periods, but those are typically local to the residence. The residence may be told when off-peak energy is available, and less costly, and set the controls of the water heater to heat during those times. From the utility's perspective, it does not know what the customer has set the timer to, or what the demands are for future heating from the unit. It may be that the residence's hot water demand occurs on a boundary time of off-peak-time to peak-time usage. During peak-charge times, the user may simply demand water anyway. The savings to the customer will only be from the water already stored in the tank which was heated during off-peak usage times. From the utility's standpoint, the demand may or may not be there during demand times, but the utility will still need to plan for it somehow, albeit likely not in an efficient manner. Although the timer system may seem like a good solution for the customer, the savings may be minimal to the customer, and the demand of the utility during peak is likely the same as if the timer were not present.

Some more efficient water heaters have extra water capacity either by having a larger tank or multiple tanks. In such water heaters, a large amount of water is heated during off-peak times and later consumed to meet the capacity of the residence such that little, if any, peak-time energy usage is needed. In fact, many other sources of energy are generated in plentiful amounts during off-peak times versus peak times. In some situations, the water heaters can be told to heat water during off-peak times, such that more hot water is available during peak times, thus using the water heater like a battery, which charges at night and is available in the morning. Although this scheme looks desirable, it has a few drawbacks. For one, the storage of hot water is not perfect. Regardless of the insulation, the water heater still dissipates heat. For example, perhaps the off-peak time is 9:00 PM and the demand time is 7:00 AM the following morning. This means that the hot water would need to be stored for 10 hours. If the home is air-conditioned, all the dissipated heat would be removed by the air-conditioning system, yielding an energy savings reversal. Further, the water heaters are expensive, and like any additional equipment, are subject to maintenance costs.

Both the timer system and the storage approach attempt to reduce the peak-time energy load, or overall cost to the customer for energy. However, neither approach can know what the demands will be during peak-time usage that is satisfactory to the customer. The water heaters can store energy, but the amount of energy needed during peak-time is still unknown. These approaches do not help the utility plan what the energy usage will be, as such the utility must have reserve capacity available in the event of variations in demand.

Air conditioning systems for residences and commercial properties require another large amount of energy. Obviously if the weather is hot, demand will be high, yet predictable. However, demand may be uncontrollable on a granular basis, as air conditioning units may be either on or off depending on the temperature in the house. In some respects, it is similar to the water heater. However, based on the size of the house, the internal temperature of the house, and the outside temperature, one can provide a predictive analysis for when an air conditioner unit will go on and for how long. An air conditioning unit can be cycled over a period of time, but it cannot have wattage reduced. It is either on or off. Having a predictive analysis of the future energy demand at the granular device level can be important in order to bring capacity on line without excessive reserve.

Another source of high residential and commercial energy usage is charging electric vehicles. Electric cars may be charged at home or at the office and driven typically during commute times. These are electric battery based systems and will absorb various amounts of charge at given rates. Some charge quickly, others charge slowly, and some charge at rates to optimize battery life. A typical usage for an electric car is to charge the battery overnight, starting between 9:00-10:00 PM until 6:00-9:00 AM the following morning for a total charging time between 9 hours to 12 hours. Most consumers feel more comfortable when heading out into the morning commute with a full charge for the commute to and back from work, plus any errands they may need to do. If the driver uses the full capacity of the battery each day, then each night the battery will need to be fully charged. Depending on the type of battery technology and the availability at the residence for energy, the battery could charge at high energy in an hour, likely the first hour the customer plugs it in. If that is the case for all customers, then the 9 PM-12 AM time would actually be a peak time of usage, and could put a strain on the utility. If the charge is spread out over the entire night, usage is less peak, although could be constantly high during that period. Additionally, if there is cost effective energy during the night, it may be best to charge the batteries faster during that period, so as to reduce reserve capacity later. However, the distribution network may not be able to handle this optimally, and the peak times may need to be staggered amongst various devices. Ideally, matching the demand, the network, and the availability would make the network more efficient. However, without knowledge of charge requests, the utility will typically fall back on historical models with reserve capacity, which is inefficient.

Utilities want to reduce reserve on-demand capacity for these and other energy uses, as it is costly. Utilities also want to allow users to consume their product, as they are a business selling a product. Utilities know that consumers do not want to overspend for their energy and often employ programs for metering energy usage. These programs often utilize devices that send a signal via radio communication to turn off the device and another signal to turn on the device. If the signal fails, the consumer often decides to cease his or her participation in the program either because they have paid too much for energy because the device remained on or because they cannot turn the device on when they need it. Further, utilities have to integrate energy sources that may come online and are plentiful and economical during non-peak times. However, it is difficult to determine what systems in the network can absorb these energy sources during non-peak times and whether there is network distribution capacity to get the energy from those sources to the consumer devices.

Phase combining of facilities to match load is a well-known process, however, it is not energy efficient or instantaneous. Because of loading factors and other factors, matching load with source requires excess capacity. If not handled properly, this can lead to brownouts or power failures. Over a large number of consumers, the loads can be averaged. For example, where 10,000 homes are on a feeder circuit, with each home having a 200 Amp server, it does not mean that the homes will collectively draw 2,000,000 million amps of power. Typically, it will be a percentage of that, but how much energy usage can vary based on the outside temperature, day of the week, time of day, and other factors. Historical mechanisms can predict usage. Strategic measurement points can define where loads currently are, but not when they will be present or for how long. Understanding the actual demand, as well as the future need, on a per customer basis would allow better matching over time of the generating facilities needed to a given feeder group. Further, modifying or controlling the expected future demand to better match generation facilities and capacities while keeping customer satisfaction to an acceptable level would reduce excess reserve capacity for utilities.

While shutting off power-consuming equipment during peak times reduces peak demand and also reduces peak demand charges, shutting off this equipment using present methods and systems disregards consumer comfort and results in the utility selling less electricity.

What is needed are systems and methods that accurately model current energy usage and what it will be in a given time frame in order to associate supply with demand. This would allow reserve capacity to be reduced, if not eliminated. At the same time, if there are devices that can absorb energy in the utility network during off-peak times, where low cost energy is available, it would potentially further reduce peak-time reserve capacity, as those devices are traditionally not demanding as much energy during the non-peak times.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In at least one embodiment, a power distribution network for distributing power to power consuming devices comprises a plurality of control devices. Each control device may be associated with at least one power consuming device having a power consumption. The power consuming devices are controlled by the control devices such that a sum of a power consumption of the power consuming devices is less than or substantially equal to a maximum power consumption for the power distribution network, the power consumption of each power consuming device is greater than or substantially equal to a minimum power consumption of the power consuming device, and the sum of the power consumption of the power consuming devices electronically connected to one power transmitting node is dependent on a desired maximum amount of transmitted power from the power transmitting node. The power transmitting node may comprise at least one electrical transformer. In some embodiments, the minimum power consumption of a power consuming device is based on comfort criteria for a user of the power consuming device. The at least one control device may be connected to a network. The control device may control power consumption of at least one power consuming device based on information received from the network. The information received from the network may comprise usage information for at least one power consuming device and/or information regarding an amount of available power. The sum of power consumption of each power consuming device may be constrained to a corresponding pre-determined amount of power.

In some embodiments, a method of managing power distribution in a power distribution network comprises modeling the power distribution network based on power criteria. The power criteria comprises: a first condition, wherein the sum of a power consumption of the power consuming devices within the power distribution network is less than or substantially equal to a maximum power consumption for the power distribution network; a second condition, wherein the sum of the power consumption of all power consuming devices within a group that are all electrically coupled with a same power transmitting node of the power distribution network less than or substantially equal to a desired maximum amount of transmitted power from the power transmitting node; and a third condition, wherein the power consumption of each power consuming device is greater than a minimum power consumption of the power consuming device. The method further comprises constraining the modeled network to determine a set of power consumption values for the power consuming devices that satisfy the power criteria and controlling power provided to at least one power consuming device based on the set of power consumption values. In embodiments of the disclosure, the at least one power consuming device is associated with a control device that controls power provided to the at least one power consuming device. In some embodiments, the control device controls power based on information received over a network to which the control device is communicatively coupled. In some embodiments, the sum of power consumption of each power consuming device is constrained to a corresponding pre-determined amount of power. In some embodiments, the minimum power consumption of a power consuming device is based on comfort criteria for a user of the power consuming device.

In some embodiments, a method of managing power distribution to at least two power consuming devices in a household is provided. A “household” may be considered a commercial property, a residential property, or combinations thereof. Where power is demanded by at least two power consuming devices of the household at a given time, at least one power consuming device of the household is prioritized over at least one other power consuming device of the household based on demand criteria and a desired power load of the power consuming devices; and power is allocated to the prioritized power consuming device relative to the at least one other power consuming device to balance the desired power load across the at least two power consuming devices over time. The demand criteria may comprise a desired minimum level of comfort to the user. To balance the desired power load, power may be reduced to the at least one other power consuming device for a period of time. In some embodiments, at least one of the power consuming devices is coupled with a control device, which may control the power provided to the power consuming device. In some embodiments, the control device receives usage information for the power consuming device. In some embodiments, the control device is in communication with a network and receives data related to at least one other control device connected to the network and operably coupled with a power consuming device. In some embodiments, in the power consuming device operably coupled with the at least one other control device is a power consuming device within the household. In some other embodiments, the power consuming device operably coupled with the at least one other control device is a power consuming device in a different household.

In some embodiments, a method of managing power distribution in a feeder circuit comprising at least two power consuming devices is provided. In some embodiments, the feeder circuit comprises multiple feeder circuits, each feeder circuit having a plurality of power consuming devices. Where power is demanded by the feeder circuit for at least two power consuming devices of the feeder circuit at a given time, at least one power consuming device of the feeder circuit is prioritized over at least one other power consuming device of the feeder circuit based on demand criteria and a desired maximum power of the feeder circuit; and power is allocated to the prioritized power consuming device relative to the at least one other power consuming device to balance power distribution across the at least two power consuming devices. The demand criteria may comprise information regarding a desired power range for power consumption. To balance power distribution, power may be reduced to the at least one other power consuming device for a period of time. In some embodiments, the prioritized power consuming device is in a different household than the at least one other power consuming device having a reduced amount of power. In some embodiments, at least one of the power consuming devices is coupled with a control device. In some embodiments, the control device is coupled to at least two power consuming devices. Power provided to at least one power consuming device may be controlled by the control device coupled to the at least one power consuming device. The control device may control power provided to the at least one power consuming device based on information received over a network to which it is communicatively coupled. The control device may receive usage information for the power consuming device. The control device may be coupled to a power consuming device in one household receives information based on power consumption by at least one other household.

A control device for a power consuming device may comprise a computing system in communication with a home network and at least one power measuring device measuring a power usage of a power consuming device, wherein the computing system receives usage information from the at least one power measuring device regarding usage of the power consuming device and controls power to the power consuming device based at least on the usage information and information received from the home network. The control device may further comprise at least one relay in electrical communication with a power supply. Power to the power consuming device is further controlled based on information received about at least one other power consuming device. Power to the power consuming device may be further controlled based on comfort criteria for the power consuming device. Comfort criteria may include an amount of power suitable to provide at least a desired minimum level of comfort to a user of the power consuming device. At least one other power consuming device may be connected to the home network. The power consuming device may be an electric water heater and the at least one power measuring device may be a temperature sensor. In some embodiments, the power consuming device is an electric vehicle. In such embodiments, an electrical signal may be supplied by the computing system to the electric vehicle, wherein the electrical signal communicates an allowable power to the electric vehicle.

In some embodiments, a control device for a power consuming device comprises a computing system in communication with the at least one power measuring device measuring a power usage of a power consuming device and in communication with a network comprising a plurality of similar control devices, wherein the computing system receives power information from the network and controls power to the power consuming device based at least on the power information received from the network. Usage information for the at least one power consuming device may be transmitted over the network. The usage information may be obtained from the at least one power measuring device. In some embodiments, power information received from the network comprises usage information from other power consuming devices of the network. In some embodiments, power to the power consuming device is controlled based at least on the comfort criteria for the power consuming device.

In at least one embodiment, a power control device is provided for a water heater having an inlet, an outlet, and a water tank in fluid communication with the inlet and the outlet. The power control device comprises a sensor disposed on an outer surface of a pipe extending downstream from the outlet and communicating usage information to a computing system, wherein based at least on the usage information received from the sensor, the computing system controls power to the power consuming device. The sensor measures at least one of temperature, pressure, or fluid flow. The power control device may further comprise a housing surrounding the sensor. In some embodiments, the power control device may further comprise insulative material between the housing and the sensor.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying figures, in which:

FIG. 1 is a schematic diagram of one embodiment of a utility power distribution network.

FIG. 2 is a schematic diagram of one embodiment of a utility power distribution network.

FIG. 3 is one embodiment of a load profile for one utility power distribution network.

FIG. 4 is a schematic diagram of a control system of one embodiment of the present disclosure.

FIG. 5 is a cross-sectional view of a control device of one embodiment of the present disclosure.

FIG. 6 is a schematic diagram of a control system for an electric vehicle charging system.

### DETAILED DESCRIPTION

The present disclosure relates to novel and advantageous systems and methods for reducing an electric utility's reserve capacity and managing energy usage during peak and off-peak times. More particularly, the present disclosure relates to devices, systems, and methods that monitor and control energy usage, both at the local level and across a power distribution network.

The present disclosure relates to accurately defining future energy usage for each power consuming device in a network. To accurately predict energy usage, the system uses intrinsic properties of the power consuming device, including for example, temperature readings, and expected outcomes, and reports this information to associate the power consuming device with a plurality of devices that use a given common feeder circuit. Based on input from or about the power consuming device, the system can determine the capacity needed for the common feeder circuit and for future time periods if the supply matches. If more power can be made available, then the time to bring it on line can be made in an orderly fashion. If it cannot, then controllers associated with those power consuming devices will appropriately modify demand on a per device basis. This allows energy usage to be controlled on a per device basis to allow averaging of total usage between a plurality of devices in a given power distribution network.

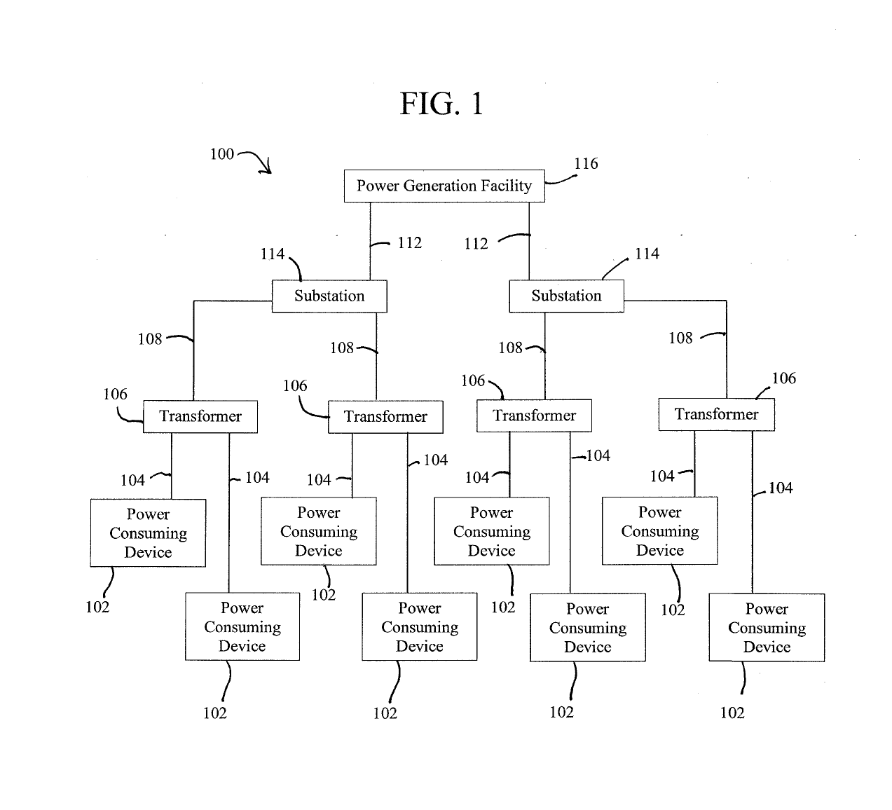

FIG. 1 shows a schematic representation of one embodiment of a utility power distribution network 100, which may comprise power consuming devices 102, transformers 106, substations 114, and power generation facilities 116. The utility power distribution network 100 consists of a plurality of power consuming devices 102, one or more of which may operate at a time at a residential or commercial property. For purposes of this disclosure each of a residential or commercial property may be considered a “household.” The power consuming devices 102 may include, but are not limited to, water heaters, air conditioners, refrigerators, HVAC systems, dishwashers, microwaves, stoves, televisions, radios, computers, hair dryers, electric vehicle charging systems, and other electronic devices. These power consuming devices 102 at each property are connected to a transformer 106 by a common feeder line 104. Groups of feeder lines 104 may be considered a “feeder circuit.” At least a second set of common feeder lines 108 connect transformers 106 to, in some embodiments, substations 114. A third set of common feeder lines 112 may connect transformers 106 or substations 114 to larger power generation facilities 116. However, power generation facilities 116 have varying capacities and may be combined to feed demand through interconnection of these facilities. Further, there may be multiple levels of transformers or substations connected to larger power generation facilities.

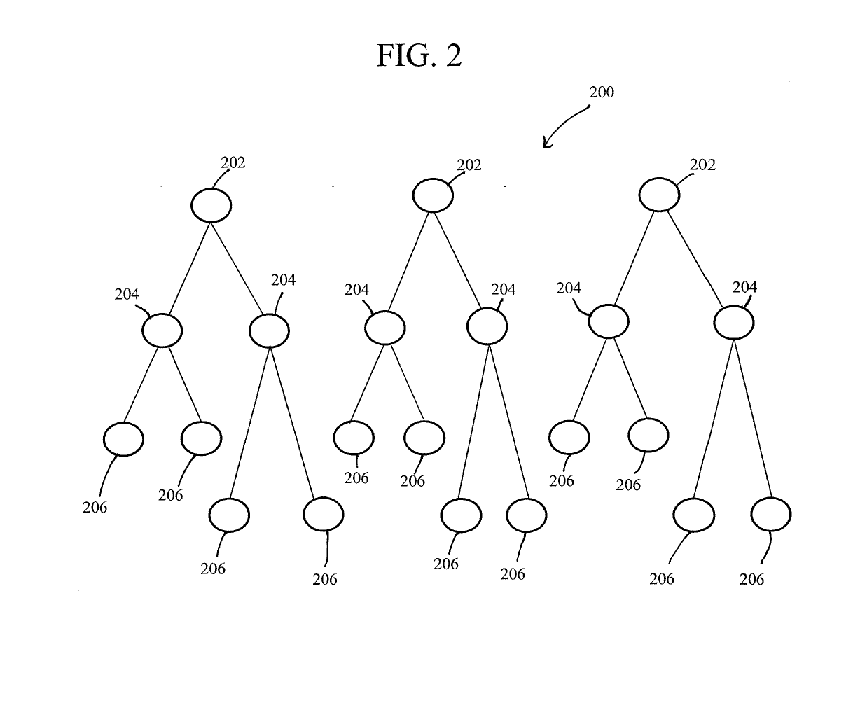

As shown in FIG. 2, the utility power distribution network shown in FIG. 1 may be modeled as a hierarchy 200 of commonly arrayed nodes, with power generating nodes 202, one or more levels of power transmitting nodes 204, and power consuming nodes 206. The power generating nodes 202 may represent power generation facilities 116. The power transmitting nodes 204 may represent transformers 106 and/or substations 114. The power consuming nodes 206 may represent power consuming devices 102 of the individual consumers, whether residential or commercial. The power distribution network may be subjected to a number of constraints, including, but not limited to the following: (1) the sum of power consumption of every power consuming node 206 may be constrained to a particular number of watts or other unit of power; (2) the sum of the power transmitted by each power transmitting node 204 may be constrained to the maximum power the power transmitting node can provide; and (3) the sum of power available to each power consuming node 206 may be balanced against the power needs at each power consuming node 206. The constrained system may then be modeled using a number of sets of equations, including but not limited to the following: (1) the sum of the power consumption of the power consuming devices, Pₓₙ, at each node may be equal to or less than the desired maximum power consumption, Pₘₐₓ, for the utility power distribution network; (2) the sum of the power consumption of the power consuming devices, Pₓₙ, at each power transmitting node may be equal to or less than a desired maximum power that each transformer may transmit, P_{T,max}, and (3) the power consumption of each power consuming device, Pₓₙ, in some embodiments, should be greater than a minimum power consumption of the power consuming device, P_{x,min}. In one embodiment, the minimum power consumption of the power consuming device may be an expected or known minimum power consumption that is needed or expected to provide a desired level of comfort to the device's user. In at least one embodiment, the desired maximum power consumption for the utility power distribution network, Pₘₐₓ and the desired maximum power transmitted by each power transmitting node, P_{T,max} may be fixed values determined by the power utility or the capacity of the system. In some embodiments, the desired maximum power consumption for the utility power distribution network, Pₘₐₓ may vary from day to day depending on factors that may include, for example, the cost for power for a given day or the available supply of power. In some embodiments, the desired maximum power transmitted by each transformer or substation, P_{T,max} is a known quantity, but transformers, for example, may nonetheless be overloaded for some time and remain suitable for use. In at least one embodiment, a maximum power consumption of any given power consuming node, P_{x,max}, may also be known based on the particular power consuming device(s) 102 forming that node. The constrained system may be determined feasible if there exists a set of power consumption values such that all equations for the modeled system are satisfied. In some embodiments, an entire solution space is available, which can be represented geometrically as a set of points within an n-dimensional convex polytope. Given such a solution space, there are many available algorithms for determining the set of optimal solutions, from which one may be chosen. Where a set of power consumption values does not exist that satisfies all equations, then the constrained system is determined to be infeasible, and the constraints may be adjusted until the constrained system is determined to be feasible (i.e., when there exists a set of power consumption values such that all equations are satisfied).

In some embodiments, the power consumption Pₓₙ of each power consuming node 206 or power consuming device 102 can be continually monitored and tracked in order to determine an optimal set of power consumption values P_{x,min} for the power consuming nodes 206 or power consuming devices 102 within the utility power distribution network 100, 200 at any given moment in time. Because not all of the power consuming devices need to be consuming power at their maximum power consumption value P_{x,max}, at any given moment, one power consuming device 102 or power consuming node 206 may be prioritized over another, which may be used on the same property or may be used at a different property within the utility power distribution network. For example, a household may have an electric water heater with a maximum power consumption value P_{x,max} of 4 kilowatts and an electric vehicle charging system with a maximum power consumption value P_{x,max} of 7 kilowatts. In this example, the transformer 104 associated with or feeding the household may only be able to allocate no more than 6 kilowatts to the household at any given moment. If at 9:00 PM, someone in the household starts charging a drained 40 kilowatt-hour battery using the electric vehicle charging system and does not need to use the car until 6:00 AM the following morning, then the electric vehicle charging system has 9 hours to charge the vehicle. Since delivering power to the car is dependent upon time and power, which are inversely proportional variables, charging it quickly requires more power and charging it more slowly requires less power. Therefore, the system could allow the electric vehicle charging system to operate at 4.4 kilowatts between 9:00 PM and 6:00 AM to fully charge the battery. While the battery is being charged, someone in the household may decide to run another power consuming device such as a dishwasher or use hot water for a shower, which causes the electric water heater to turn on and consume 4 kilowatts while the electric vehicle charging system is already consuming 4.4 kilowatts. This would cause the total power consumption at the household to exceed the 6 kilowatts allocated to the household at any given moment. At this moment, while the dishwasher is on, hot water is being used in the shower, and the battery of the electric vehicle is being charged, the electric water heater likely has a higher priority than the electric vehicle charging system with respect to the user's comfort. Knowing this, the system can then prioritize the electric water heater by providing full power (4 kilowatts) to the electric water heater and reduce the power given to the electric vehicle charging system to 2 kilowatts in order to be within the maximum amount allocated to the household. An hour later, the electric water heater may be fully charged and stops consuming power so its current power consumption goes to 0 watts. The full 6 kilowatts are now available to the electric vehicle charging system. At this time, the battery may have only gained 2 kilowatt-hours, so it still needs 38 kilowatt-hours in order to be fully charged in this example. The electric vehicle charging system can now consume the full 6 kilowatts in 6.3 hours and be fully charged before the car is needed by a user at 6:00 AM. Therefore, each power consuming device provides a minimum amount of power required to provide comfort to a user during a time interval. Based on this minimum amount of power and the constraints of the system discussed above, the system can determine power allocation to the power consuming devices in an efficient manner to prioritize energy to other power consuming devices. In this way, the utility power distribution network can provide maximum power across the system without exceeding any of the constraints of the system.

In some embodiments, it may be desirable for the system to provide a “comfort bump” to the power consuming device or node. The “comfort bump” may be, essentially, a temporary increase in energy to the power consuming device or node. The temporary increase in energy or “comfort bump” may either be scheduled or may occur based on demand by the consumer. The “comfort bump” may be applied to only one consumer or to several consumers in a group. The group may be a localized group, a group of consumers connected to the same transformer(s), or a group of consumers connected to the same substation(s). One example of when the “comfort bump” may be utilized is in the context of water heaters. In at least one embodiment, a control device may be associated with an electric water heater. In some embodiments, the control device may be placed about a supply pipe connected to the outlet of the water heater. The control device may comprise a temperature sensor to measure the temperature on the pipe as water flows through the pipe. The control device may measure temperature from a minimum temperature to a maximum temperature. The difference in time between the minimum temperature to the maximum temperature provides a time period of usage. Using information about the temperature of the water, the time period of usage, the tank size, and/or the flow rate of the water, energy usage can be determined. Energy usage may also be determined based on this information for other consumers within a group. Based on this energy usage, a “comfort bump” can be scheduled to one or more users. In some embodiments, this system may be employed without retrofitting the water heater or requiring a new tank.

In still another embodiment, the above model of monitoring and controlling power consuming devices can be expanded any distance further up the power grid topology shown in FIG. 1. That is, for example, a group of two or more of the relatively localized groups of consumers discussed above can be identified and further grouped as a larger consumer base group from a common transformer or substation. As with each localized group of consumers, this larger consumer base group, typically behind a common larger transformer, may additionally be monitored and controlled as a whole. In one embodiment, a transformer control device may, for example, be equipped with, fitted with, integrated with, or otherwise operably coupled with the common larger transformer corresponding to this larger common power feed group. The monitoring and control device of the transformer corresponding to the common power feed group may monitor and use any suitable data to control the energy delivered to the common power feed group, and may communicate with and receive data from any one or more, or all, of the monitoring and control devices of each consumer's power consuming device(s) or with a central server. The transformer control device may control or be operated (e.g. by a central server) to control the energy, or power, delivered to the plurality of localized groups of consumers in the larger consumer base group in much the same way as the control devices control the energy delivered to a localized group of consumers. The transformer control device corresponding to the larger common power feed group may monitor and use any suitable data to control the energy delivered to the common power feed group. The transformer control device may communicate with and receive data from at least one of the control devices for each localized group of consumers and/or each consumer's power consuming device(s) where energy is supplied from the transformer. Depending on the distance, the transformer control device may communicate with any other monitoring and control device through a server or directly, via a network (such as a P2P, LAN, or WAN, such as the Internet), by cellular network, or by any other suitable communication protocol. It is recognized that this same monitoring and control model can continue up the power grid topology; for instance, a substation can have a control device similar to a transformer control device. At any level of the topology, the control devices can be used generally to monitor and look for patterns in energy usage and control the corresponding transformers or power consuming devices accordingly.

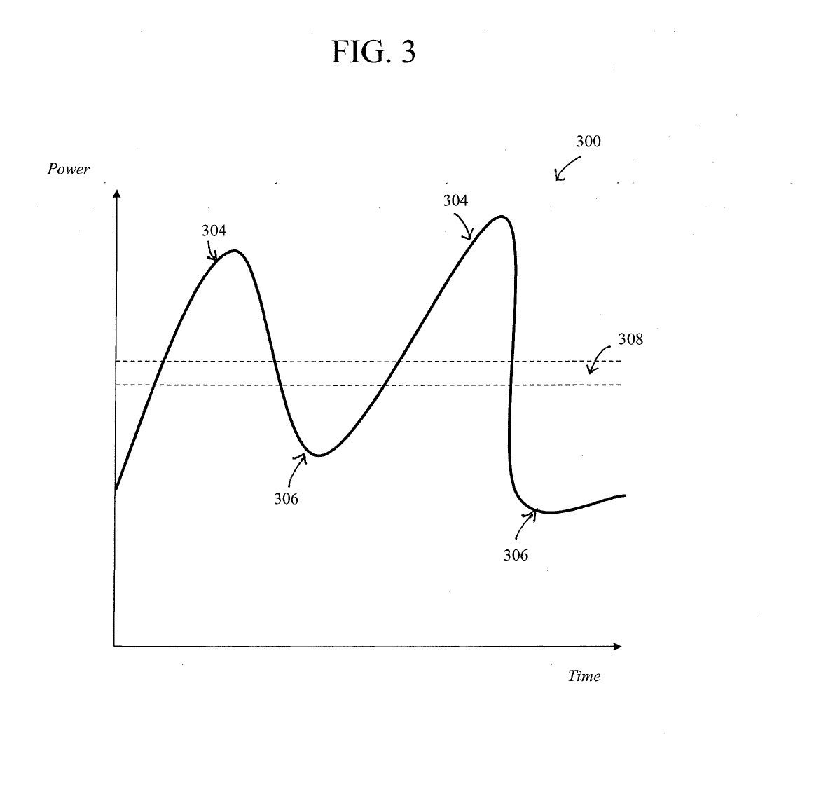

Utility power distribution networks typically have periods of peak power and periods of off-peak power. However, it is often desirable that power and energy usage be more consistent over time. FIG. 3 shows a typical energy load chart 300 showing power over time, with peak periods 304 and off-peak periods 306. A desired power range is shown at 308. Where the current power level is above the desired power range 308, money is likely being lost over that time. Likewise, where the current power level is below the desired power range 308, revenue is likely being lost due to inefficiency of the system. In some embodiments, energy usage may be controlled by the systems and methods of the present disclosure based on power usage at various portions of the utility power generation network to obtain a more consistent power level closer to that of desired power range 308. Particularly, utilities may use an energy factor to control the energy usage calculated based on the power used by the power consuming nodes and devices and/or the power transmitting nodes or transformers. For example, an energy factor may be determined by dividing the power for a transformer from the aggregate sum of power for the devices connected to that transformer. Based on the energy factor, the power used for a particular consumer can be increased or reduced by control devices for power consuming devices as described below in order for the energy factor to more closely match a desired or optimal amount. The energy factor can be recalculated over a particular time interval (e.g. every 30 seconds, every minute, etc.). This energy factor can be calculated for any or each level of the utility power distribution network (e.g. by dividing the power for the substation from the aggregate sum of power for transformers connected to the substation).

In still an additional embodiment, the above models, from down at the power consuming device level and to any extent upward on the power grid topology, may be used to regulate the universal frequency of the power grid, often referred to as frequency regulation. In general, in order to synchronize power generation sources for electrical power grid operation, the AC frequency must be held within relatively tight tolerances. More specifically, a gap between power generation and demand on the grid causes the grid frequency to move away from its nominal value. This grid frequency is the generally the same everywhere on an interconnected grid, for instance 60 Hz. While different methods for regulating the AC frequency exist, one method involves increasing or reducing the demand or load on the power grid in certain geographical regions to regulate the AC frequency back within the desired tolerances. A problem with this conventional method is that it takes far too long (e.g., on the order of minutes) to get the demand or load corrected and the AC frequency back within the desired tolerances.

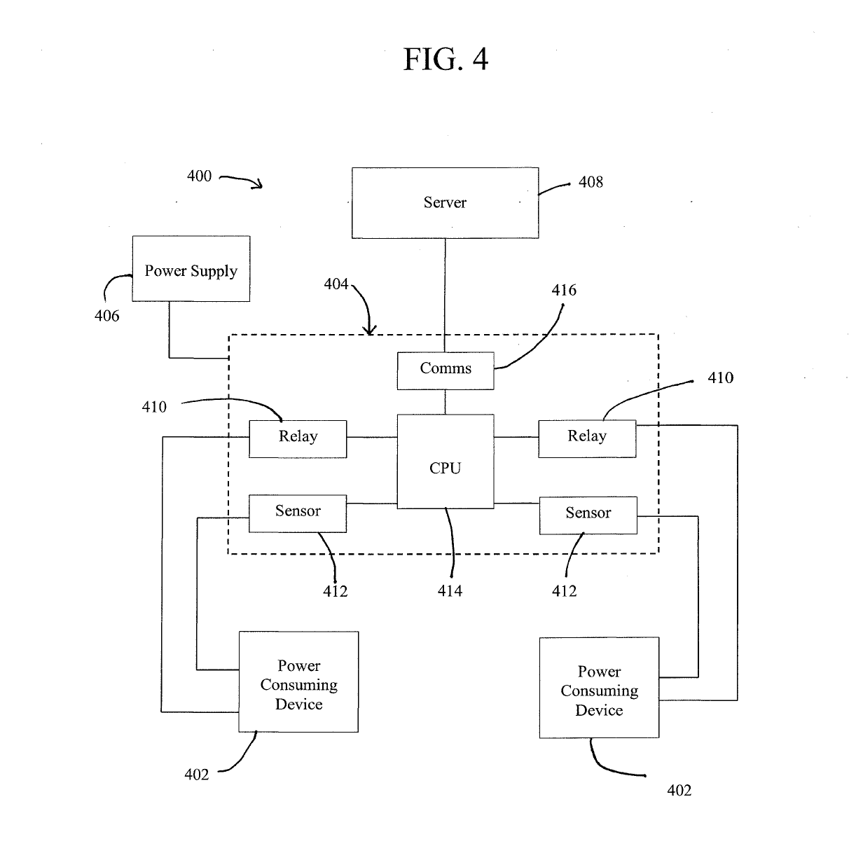

In order to manage energy usage, data from each consumer, and more particularly each power consuming device, may be desirable. With general reference to FIG. 4, in one embodiment of control system 400, the control system 400 comprises at least a power consuming device 402 and a control device 404. The consumer's power consuming device 402 may be equipped with, fitted with, integrated with, or otherwise operably coupled with a control device 404. The power consuming device 402 may include a water heater, air conditioning system, electric car charging system, any other suitable appliance, or any other electronic device. The power consuming device 402 may receive power via a power supply 406. The power supply 406 may be a transformer, a substation, a battery or some other power source electrically communicating with the power consuming device 402. In at least the embodiment shown, the power supply 406 is connected to the control device 404, which transmits the power, or restricts or allows the transmission of power, to the power consuming device 402.

The control device 404 may be configured to measure current draw or control power to one or more power consuming devices 402. The control device 404 may in some embodiments measure the current drawn or the amount of energy used by the power consuming device 402 at various times or over a period of time. In other embodiments, the control device 404 may receive such data from another device or source, directly or via a network connection. Whether based on such measurements or not, the control device 404 may control the power delivered to the power consuming device 402 at a given time or over a period of time. In some embodiments, at least some of the components of the control device 404 identified below may be part of a separate control device while some may be part of the power consuming device 402. In some embodiments, the control device 404 may be located remotely from the power consuming device. In some embodiments, the power consuming device 402 may be manufactured with a control device 404 already installed or built-in. In some embodiments, the control device 404 may be installed on or near the power consuming device 402. In some embodiments, the control device 404 may be installed in line with the power supply 406 for the power consuming device 402. The control device 404 may be positioned between the power supply 406 and the power consuming device 402. In some embodiments, the control device 404 may be positioned on a fluid line downstream from the outlet of a water tank, as previously described.

In at least one embodiment, the control device 404 comprises one or more relays 410 operably connected with a power measuring device 412. The relays 410 may be mechanical relays or solid state relays. In at least one embodiment, the relays 410 are configured for electrical connection to the power supply 406 and, in some embodiments, to the power consuming device 402. The power measuring device 412 may comprise one or more of an ammeter, multimeter, wattmeter, voltmeter, current transformer, Rogowski coil, and sensor including, but not limited to, temperature sensor and flow sensor. The control device 404 may comprise one or more power measuring devices 412 for each power consuming device 402 connected with the control device. In some embodiments, the power measuring device 412 could be sensors or other measuring devices already installed or part of the power consuming device 402.

The control device 404 may utilize various data to determine and/or measure the amount of energy consumed by the power consuming device 402. The control device 404 may utilize data including, but not limited to, the times of day the power consuming device 402 is consuming the energy; the duration of each current draw; the amount of current draw; manufacturing and design specifics pertaining to the power consuming device 402; current or past temperature(s); or any other suitable characteristic about the power consuming device 402. The data may be received, obtained, or determined by the power measuring device 412. The control device 404, in some embodiments, may also use any suitable external data, such as but not limited to, data relating to the power grid and/or the current or future demand or load thereon, in order to control the power consuming device more efficiently. In at least one embodiment, the control device 404 may be in electrical communication with a server 408, which may be located remotely. The server 408 may be communicatively connected to multiple control devices 404 at various locations. The control device 404 may retrieve data from the server 408 or may store data on the server 408 related to power usage by the power consuming device. In at least one embodiment, the control device 404 may include a computing system 414, including, but not limited to, a mounted chip system such as a system commonly called Raspberry Pi™. Of course, any other type of computing system may be used, and the various embodiments of the present disclosure are not limited to Raspberry Pi™ systems. Power from the power supply 406 or other power source can be used to power the computing system 414. The computing system 414 may also be in electrical communication with the relay 410. In at least one embodiment, the computing system comprises a NAND gate or similar control or override mechanism, such that if the computing system 414 is not fully functioning and its signal to the relay 410 is not sent, the NAND gate will still send a positive control signal to the relay 410 and keep the relay 410 closed so that the power consuming device 402 can still function. The computing system 414 may also be in electrical communication with the power measuring device 412 such that the system retrieves data from the power measuring device 412. In at least one embodiment, the outputs of the power measuring device 412 are connected to the computing system 414.

Based on the data received by the power measuring device 412, in one embodiment, the computing system 414 may cause the relay 410 to open or close to provide a determined amount of power to the power consuming device 402 in increments of a predetermined wattage. The wattage may depend on the type, brand, size, etc. of the power consuming device 402, and may be different for different power consuming devices 402, or for power consuming devices 402 in different geographic locations. Any other suitable information may be, additionally or alternatively, used to determine the wattage delivered per increment to a power consuming device 402. In one embodiment, the control device 404 may control the energy to the power consuming device 402 to more efficiently utilize power. The control device 404 may control the energy to the power consuming device 402 by, in some embodiments, permitting power to be more efficiently or cost-effectively delivered during non-peak times. The control device 404 may control the energy to the power consuming device 402 by, in some embodiments, delivering power more spread out through a combination of peak and non-peak times, rather than only during the peak time. The control device 404 may control the energy to the power consuming device 402 by, in some embodiments, delivering power to the power consuming device 402 for only a specific duration of time. The control device 404 may control the energy to the power consuming device 402, in some embodiments, by limiting the amount of energy delivered to the power consuming device 402 (e.g., in increments of power as described above) similar to using a dimmer switch. The control device 404 may otherwise control the amount of energy to the power consuming device 402 by any other method or suitable combination of methods. In general, the control device 404 may control when the power consuming device gets power and/or how much power it gets at a time. The determination of when the power consuming device 402 gets power and/or how much power it gets at a time may be based on factors which may include, but are not limited to, load on the power grid by the consumer or a related group of consumers, peak energy times, off-peak energy times, availability of alternative energy sources, user comfort, and other factors. Typically, although not a requirement of the present disclosure, the control device 404 may control the energy delivered to the power consuming device in a manner so as to be relatively unnoticeable or non-disruptive to the consumer.

The control device 404 may additionally include a communication module 416 for communicating via cellular, WiFi, hardwire connection, or any other suitable type of communication protocol. In one embodiment, the control device 404 may communicate via a network, such as a P2P network, LAN network, or a WAN network, such as the Internet, with other remote devices, such as a remote monitoring and control server, which may have additional data and/or control, algorithms for controlling the consumer's corresponding power consuming device 402, and which may be in communication with a plurality of other monitoring and control devices. In one embodiment, where a consumer has multiple power consuming devices 402 each equipped with a control device 404 of the present disclosure, the multiple power consuming devices 402 may be in communication with each other, directly or via a local network (e.g., P2P, LAN, etc.), and may use data received from one another to control the energy delivered to each of the power consuming devices 402 more efficiently or cost-effectively as a whole. That is, each control device 404 may control the energy delivered to its respective power consuming device 402 based, not only on data related to its respective power consuming device, but also on the energy data, usage, or requirements of the other power consuming devices received from the other monitoring and control devices within a household. In some embodiments, the control device 404 may include an override feature, button, switch, or other type of toggle to override control of the monitoring and control device of the power consuming device, such as for example, when a consumer requires or desires unrestricted use of the power consuming device 402.

The control device may be connected to the network and may use information from other control devices or other power consuming devices connected to the network. The control device may in some embodiments, use information from other control devices or other power consuming devices only within a household. In some embodiments, the control device may use information from a subset of control devices or power consuming devices within the household or a subset of other control devices and/or power consuming devices connected to the network, whether within or not within the household. The control device may rely on data from any of these networked connections in order to more efficiently provide or control power to a given power consuming device. In some embodiments, particularly where a household may generate its own power, be removed or disconnected from the “power grid”, or use a back-up generator, the control device can still control power provided to one or more power consuming devices within the household in order to more efficiently distribute power and balance the power load of the household. In some embodiments, the control device may use or rely on data from just a local network, such as P2P or LAN network, while in other embodiments, it may use data alternatively or additionally from a broader network of connected devices. In some embodiments, the information from the network utilized may be dynamically selected with respect to how much information is used at any given time and from which connected devices information is obtained or received. In some embodiments, if for some reason a household is disconnected from a broader network, such as a WAN or the Internet, the control device or the power consuming device may nonetheless operate with information exchanged within a more localized network, such as a P2P or LAN network, or independently without network information. When the network connection is resumed, the control device may resume normal communication with other network connected devices.

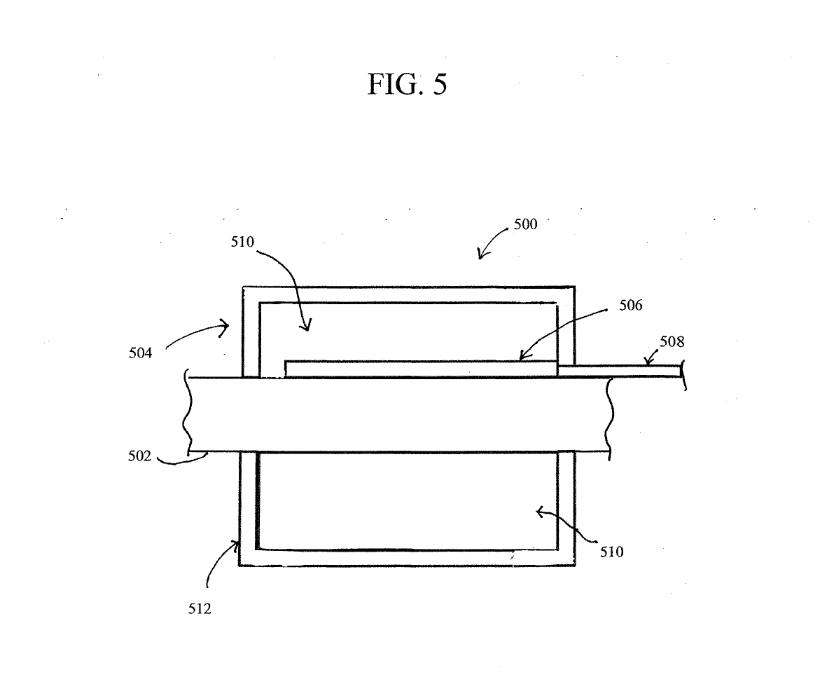

One embodiment of a control system 500 and a control device 504 is shown in FIG. 5 and particularly used with an electric water heater. For example, in one embodiment, a power consuming device such as a water heater may be instrumented with a control device 504 to determine the demand capacity available to the customer and, based upon tank and design specifics, how long the refresh cycle will take into the future. As shown in FIG. 5, the control device 504 may be installed on an outer surface of a pipe 502 extending from the outlet of the electric water heater. The control device 504 comprises one or more sensors 506 and a communication wire 508 for electrical communication between the sensor(s) 506 and a computing system and/or server. The communication wire 508 may be connected to an antenna for wireless electrical communication with the computing system and/or server. A sensor 506 may, in some embodiments, be a temperature sensor. In at least one embodiment, the sensor contacts the outer surface of the pipe 502 in order to obtain data regarding the temperature of the pipe, which is proportional to the temperature of the water passing through the pipe 502. The data obtained from the sensor 506 is transmitted to the server and/or computer system via the communication wire 508. The control device may further comprise an insulation layer 510 to provide a more accurate temperature reading by the sensor 506. The control device may further comprise a housing 512 configured to protect the insulation layer and the sensor. In at least one embodiment, the housing 512 surrounds the insulation layer 510 and the sensor 506. The housing may be shaped as a cylinder or may have other configurations.

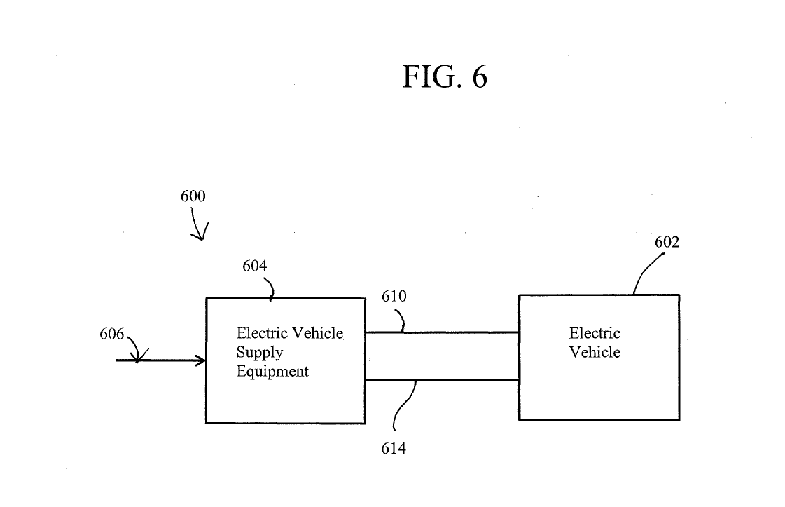

FIG. 6 shows one embodiment of an electric vehicle charging system 600, which may comprise an electric vehicle 602 that has a battery requiring charging, electric vehicle supply equipment (“EVSE”) 604, a power supply line 606, a pilot wire 610, and power cabling 614. The electric vehicle 602 may be equipped with, fitted with, integrated with, or otherwise operably coupled with the EVSE 604 to charge or replenish the charge for at least one battery for the electric vehicle 602. Although the description below is addressed to charging a battery for the electric vehicle which is installed on the vehicle, it is appreciated that the system and methods described herein may be suitable for charging a replacement battery that is not installed on the electric vehicle 602 or for charging a battery removed from the electric vehicle 602.

The electric vehicle 602 may receive power via a power supply. The power supply may be a transformer, a substation, a battery or some other power source electrically communicating with the power consuming device. The power supply line 606 may be configured for connection to the EVSE 604, which transmits a signal to the electric vehicle that restricts or allows the transmission of the power to the electric vehicle. The power supply line 606 may be a 110-volt AC line, 240-volt AC line, or 480-volt AC line, or may have some other power draw capacity. The power supply line 606 may in some embodiments be a wire connected to the EVSE 604. The wire has a gauge size that is dependent on the amount of current that will be fed through the wire. The greater the current, the smaller the wire gauge size in some embodiments. The power supply line 606 may be electrically connected to a transformer to receive power from the utility power distribution network. The power supply line 606 carries power to the EVSE 604, which is also called an “electric vehicle charging station,” “electric vehicle servicing equipment,” or an “electric recharging point”. The EVSE 604 is configured to supply electric energy to recharge the electric vehicle 602 from the power supply through power cabling 614. The EVSE 604 may be configured to supply an electrical signal to the electric vehicle 602 via the pilot wire 610, which may be a low-voltage signaling wire that provides an electrical signal to the electric vehicle 602. The electrical signal communicates to the electric vehicle 602 how much power the electric vehicle 602 may draw from the power supply 606 through the EVSE 604 at any given moment. The electrical signal may comprise a pulsing signal, and the system may use pulse-width modulation to transmit information to the electric vehicle. The signal from the pilot wire 610 may comprise square waves with varying duty cycles, wherein each duty cycle represents a portion of data related to the allowable amount of power. Based on the signal received by the electric vehicle 602 from the pilot wire 610, the electric vehicle 602 draws an amount of power from the EVSE 604 that is less than or equal to the allowable amount of power indicated by the signal.

The EVSE 604 may include a computer system and may utilize various data to determine the allowable amount of power and provide a suitable signal to the vehicle 602 according to the allowable amount of power. The EVSE 604 may utilize data received from a server, stored data, or from the electric vehicle 602 to determine the allowable amount of power, including, but not limited to, the times of day the electric vehicle 602 is being charged; the duration of each current draw; the amount of current draw; the amount of current charge of the battery of the electric vehicle 602 relative to its capacity; the driver's usage of the electric vehicle 602; manufacturing and design specifics pertaining to the electric vehicle 602; or any other suitable characteristic about the electric vehicle 602, its usage, and the available power supply. The EVSE 604, in some embodiments, may also use any suitable external data, such as but not limited to, data relating to the power grid and/or the current or future demand or load thereon, in order to determine the allowable amount of power and the electrical signal related thereto. In at least one embodiment, the EVSE 604 may be in electrical communication with a server which may be located remotely. The server may be communicatively connected to multiple EVSEs or control devices as described above. The EVSE 604 may retrieve data from the server or may store data on the server related to power usage by the electric vehicle 602, power storage by the electric vehicle 602, and other suitable characteristics of the electric vehicle 602.

In at least one embodiment, the EVSE 604 may include a computing system. Power from the power supply can be used to power the computing system. The computing system may be in electrical communication with the pilot wire 610. The computing system may also be in electrical communication with the electric vehicle 602 such that the system retrieves data from the electric vehicle. In at least one embodiment, the EVSE 604 comprises an automatic override mechanism, such that if the electrical signal is not sent, the a positive control signal can be sent so that the electric vehicle may continue to be charged. In some embodiments, the EVSE may include a user override feature, button, switch, or other type of toggle to override control of the monitoring and control device of the EVSE 604, such as for example, when a consumer requires or desires unrestricted charge of the electric vehicle 602.

In one embodiment, the EVSE 604 may control the power delivered to the electric vehicle 602 to more efficiently utilize power. The EVSE 604 may control the energy to the electric vehicle 602 by, in some embodiments, sending a signal relative to the allowable amount of power to permit power to be more efficiently or cost-effectively delivered during non-peak times. The EVSE 604 may control the power delivered to the electric vehicle 602 by, in some embodiments, sending a signal relative to the allowable amount of power to spread out power usage through a combination of peak and non-peak times, rather than only during the peak time. The EVSE 604 may control the energy to the electric vehicle 602 by, in some embodiments, sending a signal relative to the allowable amount of power to permit delivering power for only a specific duration of time. The EVSE 604 may otherwise control the amount of energy to the electric vehicle 602 by modulating the signal provided via the pilot wire 610 or by any other method or suitable combination of methods. The determination of the allowable amount of power to the electric vehicle 602 may be based on factors which may include, but are not limited to, load on the power grid by the consumer or a related group of consumers, peak energy times, off-peak energy times, availability of alternative energy sources, user comfort, usage of other power consuming devices, and other factors. Typically, although not a requirement of the present disclosure, the EVSE 604 may control the energy delivered to the electric vehicle 602 in a manner so as to be relatively unnoticeable or non-disruptive to the consumer.

The EVSE 604 may additionally include a communication module for communicating via cellular, WiFi, hardwire connection, or any other suitable type of communication protocol. In one embodiment, the EVSE 604 may communicate via a network, such as a P2P network, LAN network, or a WAN network, such as the Internet, with other remote devices, such as a remote monitoring and control server, which may have additional data and/or control algorithms for determining the amount of allowable power for the electric vehicle 602, and which may be in communication with a plurality of other monitoring and control devices. In one embodiment, where a consumer has multiple power consuming devices each equipped with a control device of the present disclosure and an electric vehicle, the multiple power consuming devices may be in communication with each other, directly or via a local network (e.g., P2P, LAN, etc.), and may use data received from one another to control the energy delivered more efficiently or cost-effectively as a whole. That is, each control device may control the energy delivered to its respective power consuming device based, not only on data related to its respective power consuming device, but also on the energy data, usage, or requirements of the other power consuming devices received from the other monitoring and control devices within a household.

While the above discussion has focused on the use of the control device to control energy to one power consuming device, energy for a group of consumers' power consuming devices with control energy devices may be controlled as discussed above. In general, in one embodiment, for a given localized group, the amount of relatively large current or power draw for the group (such as current draw by water heaters, electric vehicles, air conditioning systems, etc.) may be determined and may be predicted for the future. The localized group of consumers may be determined based on one particular block, street, neighborhood, community, transformer group or another selected grouping of consumers. Based on this information and/or other data, the control devices, models, and methods of the present disclosure may be utilized individually or in combination to control the amount of energy, or power, delivered to a localized group of consumers and to each power consuming device of those consumers having a corresponding control device, so as to smooth the load over time. More specifically, the various embodiments of the present disclosure may utilize one or more control devices to smooth the energy load within each household and across a localized group of consumers. Again, typically, although not a requirement of the present disclosure, the control devices may control the energy delivered across a localized group of consumers in a manner so as to be relatively unnoticeable or non-disruptive to the consumers. As one example, for each household in the localized group, a control device may control the household's water heater to utilize power and heat water mainly during overnight off-peak times. Moreover, for a localized group of households, the time of night at which a water heater for a given household is delivered power for heating water may be staggered across the localized group of consumers, such that not all households are consuming power to heat water at the same time of night.

In one embodiment, with the control devices of the present disclosure, and particularly with the topology of monitoring and devices disclosed herein, upon stray of the AC frequency as discussed above, the demand or load, and any scheduled future demand or load, in selected geographical regions of the power grid can be relatively immediately (e.g., within seconds) altered, and in many cases relatively smoothly and without significant disruption to consumers, so as to correct the universal AC frequency to within the desired tolerances.

While generally described with reference to power consuming devices, such as water heaters, air conditioning systems, and electric car charging systems, it is recognized that any other suitable power consuming device or appliance may be regulated in the manners described herein.

For purposes of this disclosure, any computer system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, etc.) using any of a variety of commercially available bus architectures.

One or more programs or applications may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. The programs or applications may be stored locally or retrieved from a server for execution. One or more processors may execute applications or programs to run systems or methods of the present disclosure, or portions thereof, stored as executable programs or program code in the memory, or received from the Internet or other network. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

Embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to schematic diagrams of systems and methods. It is understood that methods involving each block of the schematic diagrams, and/or combinations of blocks in the schematic diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description, various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A power distribution network for distributing power to power consuming devices, the power distribution network comprising:
a plurality of control devices, each control device associated with at least one power consuming device having a power consumption,
wherein the power consuming devices are controlled by the control devices such that a sum of a power consumption of the power consuming devices is less than or substantially equal to a maximum power consumption for the power distribution network, the power consumption of each power consuming device is greater than or substantially equal to a minimum power consumption of the power consuming device, and the sum of the power consumption of the power consuming devices electronically connected to one power transmitting node is dependent on a desired maximum amount of transmitted power from the power transmitting node.

2. The power distribution network of claim 1, wherein the minimum power consumption of a power consuming device is based on comfort criteria for a user of the power consuming device.

3. The power distribution network of claim 1, wherein at least one control device is connected to a network.

4. The power distribution network of claim 3, wherein the control device controls power consumption of the power consuming devices based on information received from the network.

5. The power distribution network of claim 4, wherein the information received from the network comprises usage information for at least one power consuming device.

6. The power distribution network of claim 4, wherein the information received from the network comprises information regarding an amount of available power.

7. The power distribution network of claim 1, wherein the sum of power consumption of each power consuming device is constrained to a corresponding pre-determined amount of power.

8. The power distribution network of claim 1, wherein a power transmitting node comprises an electrical transformer.

9. A method of managing power distribution in a power distribution network, the method comprising:
modeling the power distribution network based on power criteria, wherein the power criteria comprises:
a first condition, wherein the sum of a power consumption of the power consuming devices within the power distribution network is less than or substantially equal to a maximum power consumption for the power distribution network;
a second condition, wherein the sum of the power consumption of all power consuming devices within a group that are all electrically coupled with a same power transmitting node of the power distribution network less than or substantially equal to a desired maximum amount of transmitted power from the power transmitting node; and
a third condition, wherein the power consumption of each power consuming device is greater than a minimum power consumption of the power consuming device;
constraining the modeled network to determine a set of power consumption values for the power consuming devices that satisfy the power criteria; and
controlling power provided to at least one power consuming device based on the set of power consumption values.

10. The method of claim 9, wherein the at least one power consuming device is associated with a control device that controls power provided to the at least one power consuming device.

11. The method of claim 10, wherein the control device controls power based on information received over a network to which the control device is communicatively coupled.

12. The method of claim 9, wherein the sum of power consumption of each power consuming device is constrained to a corresponding pre-determined amount of power.

13. The method of claim 9, wherein the minimum power consumption of a power consuming device is based on comfort criteria for a user of the power consuming device.
